(19) United States
(12) Patent Application Publication
(10) Pub. No.: US 2012/0134519 A1
(43) Pub. Date: May 31, 2012

(54) Integrated television Mount and Audio System

(76) Inventors: Douglas G. Caldes, Orlando, FL (US); Raymond I. Leake, Debary, FL (US)

(21) Appl. No.: 12/955,180

(22) Filed: Nov. 29, 2010

(51) Int. Cl. H04R 5/02

(52) U.S. Cl. 381/306

(57) ABSTRACT

A television mount incorporating an integrated audio system. The mount attaches the television to a wall or a pedestal. The mount includes an electronics/subwoofer enclosure. This enclosure house an audio amplifier and a low-range speaker. One or more external speaker supports are included in the mount—preferably by attaching the supports to the electronics/subwoofer enclosure. The speaker supports are preferably made adjustable so that the degree of extension from the mount may be adjusted by the user.

### CROSS-REFERENCES TO RELATED APPLICATIONS

Not Applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of audio-visual systems. More specifically, the invention comprises a television mount incorporating an integrated audio system.

2. Description of the Related Art

The nature of televisions has changed dramatically over the past several years. Picture-tube based televisions were inherently bulky, with the depth of the unit being comparable to its other dimensions. While this made the units visually unappealing, the bulky cabinetry did provide ample volume for the inclusion of integrated audio systems. A picture-tube television having a diagonal frontal dimension of 40 inches (about 100 centimeters) typically had a cabinet depth of about 30 inches (about 75 centimeters).

With the advent of modern electronics and their inherent space efficiency, much of the cabinet space available in picture-tube televisions was vacant. Thus, a television manufacturer could easily incorporate relatively large audio speakers (such as 4 inches by 6 inches) into the cabinet. Speakers of this size allowed a rich tonal quality to the sound produced.

The prior art changed dramatically when tube-less designs appeared. These are generally referred to as “flat screen” televisions. Examples include liquid crystal displays (“LCD's”) and plasma displays. Flat screen televisions are typically very thin. In fact, limiting the depth of a flat screen television has become a styling goal for most manufacturers. A flat screen television with a diagonal frontal dimension of 40 inches (100 centimeters) may have a depth less than two inches (5 centimeters). The television's perimeter is typically made even thinner. The perimeter is often less than one inch (2.5 centimeters) thick.

The visual performance of modern flat screen televisions is a significantly better than picture-tube based televisions. However, the limited space within the “cabinet” of a flat screen (to the extent one can even call such a thin structure a cabinet) leaves very little room for audio components. The solution has been to use increasingly smaller audio transducers.

Another styling goal has been to occupy as much of the forward-facing surface as possible with the television display itself. Thus, the audio transducers which are present are often now in a sub-optimal orientation; that is, the speaker cones face to the side or even to the rear of the television and do not direct the sound energy toward the user. The result is that—while the video performance of these devices has progressed markedly—the audio performance has at best remained stagnant and has in most instances even deteriorated.

A consumer buying a high-performance flat screen television often desires a “home theater” experience in which the sound quality is comparable in volume and range to the sound heard in a movie theater. Such a consumer will not be satisfied with the limited acoustic performance of a modern flat screen television. The consumer must bring in additional components to solve this problem.

Audio solutions for home theater systems are widely varied and complex. FIG. 1 gives one simple example. Flat screen television 10 has been mounted on a wall using one of the available mounting systems. Separate components are housed in rack 24 (which may be anything from a simple electronics rack to an elegant piece of furniture designed specifically to conceal the components). Rack 24 typically encloses a cable decoder box, a DVD player, a video game console, and an amplifier 12. The amplifier may be a sophisticated PRO/LOGIC decoding system (such as offered by Dolby Laboratories of San Francisco, Calif.) that splits the audio signal into at least four channels—typically referred to as left, center, right, and rear (sometimes known as a “subwoofer” channel).

Cables run between rack 24 and flat screen television 10. In this example, a two channel audio cable 14 is run from the television to amplifier 12. In other examples, a single HDMI cable may be connected from the cable box to the amplifier, with a second HDMI cable running from the amplifier to the television. These represent a hard-wired connection between the amplifier and the television.

The speakers are also connected to the amplifier. Left channel speaker 22 is connected via speaker cable 26. Center channel speaker 16 is connected via its own cable (not visible in the view). Right channel speaker 20 and subwoofer 18 are also connected to the amplifier via speaker cables 26.

The system shown in FIG. 1 produces reasonably good audio performance. However, the reader may easily perceive the irony of the situation. In creating ever-thinner flat screen televisions the manufacturers have created an elegant and “clean” appearance for the visual aspects of a home entertainments system. However, in so doing, they have reduced the audio performance of the television itself to an unacceptably low level. The available remedy for this problem is to add numerous other components and cables which completely destroy the visual aesthetic originally sought.

The present invention seeks to resolve this dilemma by integrating an external audio system into the television's mount. Modern television mounts attach to the rear of the television or the base of the television. The volume immediately behind the television is typically not used.

FIG. 2 represents a common wall mounting system for a television. In this example, wall bracket 28 is attached to the wall by passing bracket mounting bolts 36 through the bracket and into the wall studs or masonry. Uprights 32 on TV bracket 30 are attached to the rear of the flat screen television by passing TV mounting bolts 34 through the uprights and into the television. TV bracket 30 is then slidably engaged with wall bracket 28 (with the television attached).

Many other mounting systems exist. The TV bracket in some of these other systems attaches to the wall bracket by pivoting into position rather than sliding. The general concept of having a first portion attached to the wall and a second portion attached to the television is used in nearly every prior art mounting system.

A significant gap typically remains between the rear of the television and the wall itself. This gap is mostly occupied by the mount itself. The present invention seeks to take advantage of this potentially available space by creating a mounting system with an integrated high-fidelity audio system in this space.

### BRIEF SUMMARY OF THE INVENTION

The present invention comprises a television mount incorporating an integrated audio system. The mount attaches the television to a wall. Alternatively, the mount incorporates a pedestal so that the television and associated audio devices may be placed upon a flat surface. A main bracket and television bracket of suitable design are included. As for the prior art, the main bracket may be attached to the wall and the television bracket attached to the television. The two components are preferably designed to easily engage so that the user may hang the television on the wall without the need for complex operations.

The main bracket mounts an electronics/subwoofer enclosure. This enclosure house an audio amplifier (which may be a sophisticated frequency splitting device such as a PRO/LOGIC system) and a low-range speaker. A resonance chamber and bass port are included in the electronics/subwoofer enclosure so that the low-range speaker can accurately project the low-frequency portion of the audio spectrum.

One or more external speaker supports are included in the mount—preferably by attaching the supports to the electronics/subwoofer enclosure. The speaker supports are preferably made adjustable so that the degree of extension from the mount may be adjusted by the user.

In the preferred embodiment a separately adjustable support is provided for a left speaker, a center speaker, and a right speaker. Suitable audio speakers are attached to the speaker supports. The location of the speakers is then adjusted so that they lie beyond the perimeter of a television attached to the mount. The speakers may be wired to the electronics housed within the electronics/subwoofer enclosure. The signal to each speaker may also be transmitted wirelessly if desired. The result is an integrated audio/video system in which all components are located together in one aesthetically clean package.

### BRIEF DESCRIPTION OF THE SEVERAL VIEWS OF THE DRAWINGS

FIG. 1 is a perspective view, showing a prior art home theater installation.

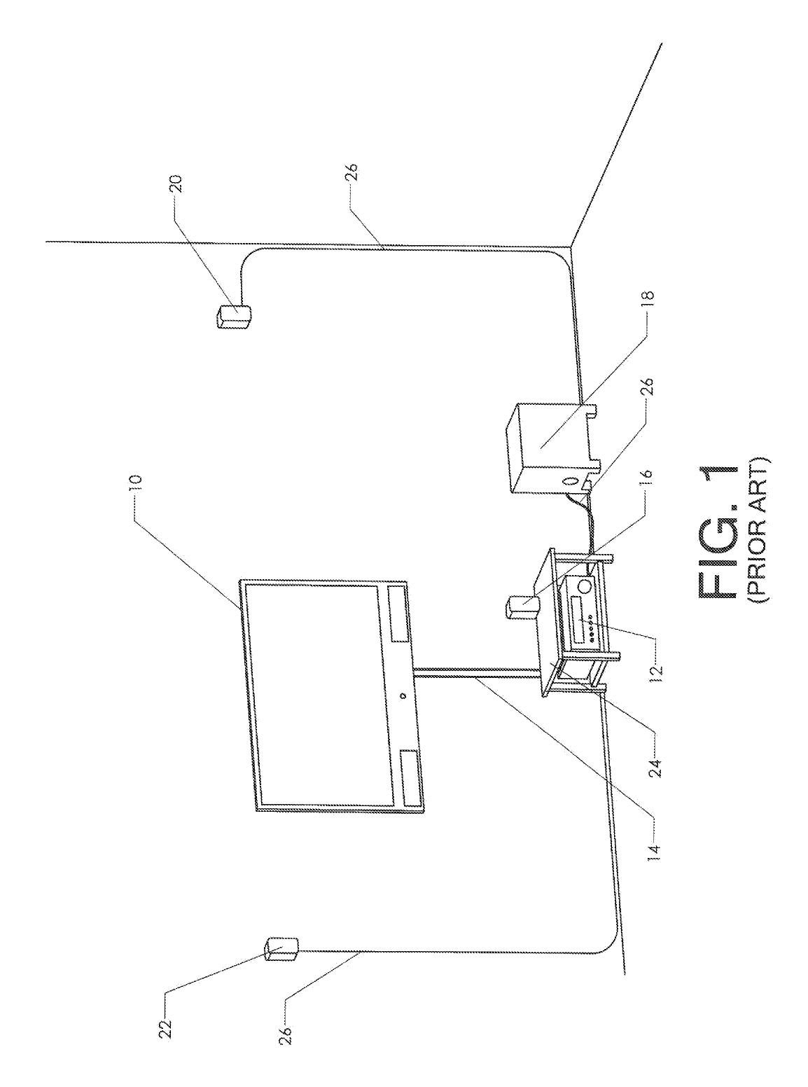

FIG. 2 is a perspective view, showing a prior art television mount.

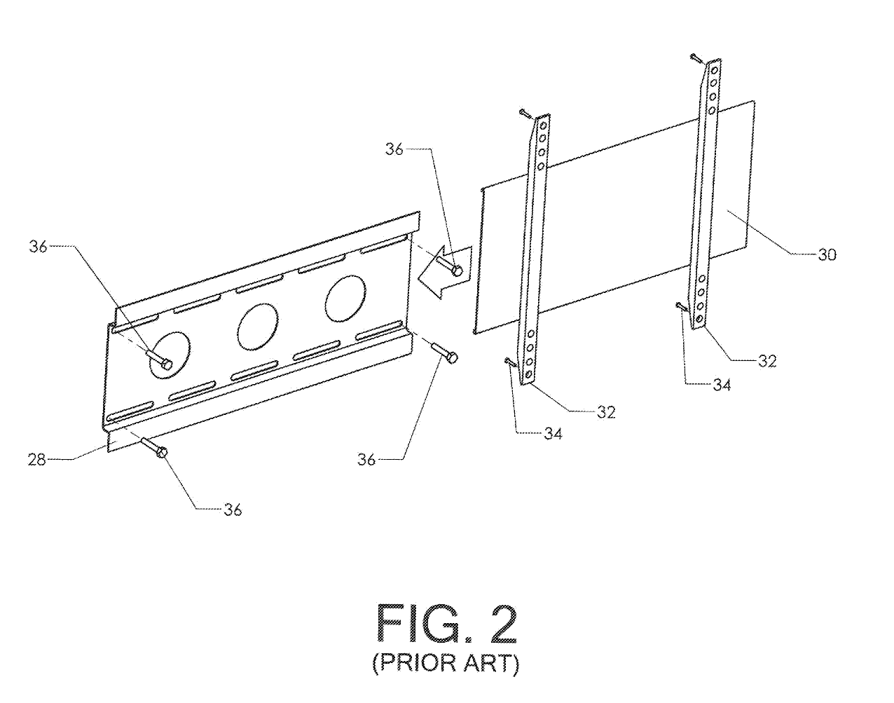

FIG. 3 is a perspective view, showing a wall bracket made according to the present invention.

FIG. 4 is a perspective view, showing the addition of an electronics/subwoofer enclosure, speaker supports, and speakers to the wall bracket.

FIG. 5 is a perspective view, showing the rear of a typical flat screen television.

FIG. 6 is a perspective view, showing the addition of a pair of TV brackets to the rear of a flat screen television.

FIG. 7 is a perspective view, showing the addition of a gripping bracket to each TV bracket.

FIG. 8 is a perspective view, showing the attachment of a flat screen television to the wall bracket.

FIG. 9 is a perspective view, showing a television attached to the present invention.

FIG. 10 is an elevation view, showing the placement of the components behind the television.

FIG. 11 is an exploded perspective view, showing the electronics/subwoofer enclosure.

FIG. 12 is a perspective view, showing the interior of the electronics/subwoofer enclosure.

FIG. 13 is a perspective view, showing an optional suspended shelf.

FIG. 14 is a perspective view, showing an alternate embodiment in which the center speaker is placed above the television.

FIG. 15 is a perspective view of another alternate embodiment in which a pedestal is provided.

REFERENCE NUMERALS IN THE DRAWINGS

| | | | |
|---|---|---|---|
| 10 | flat screen TV | 12 | amplifier |
| 14 | audio cables | 16 | center channel speaker |
| 18 | subwoofer | 20 | right channel speaker |
| 22 | left channel speaker | 24 | rack |
| 26 | speaker cable | 28 | wall bracket |
| 30 | TV bracket | 32 | upright |
| 34 | TV mounting bolt | 36 | bracket mounting bolt |
| 38 | main bracket | 40 | upper flange |
| 42 | lower flange | 44 | opening |
| 46 | mounting slot | 48 | enclosure mounting hole |
| 50 | electronics/subwoofer enclosure | 52 | left speaker assembly |
| 54 | right speaker assembly | 56 | center speaker assembly |
| 58 | left support | 60 | right support |
| 62 | center support | 66 | threaded receiver |
| 68 | power connection | 70 | A/V connection block |
| 72 | TV bracket | 74 | TV bolt |
| 76 | gripping bracket | 78 | upper notch |
| 80 | lower notch | 82 | locking screw |
| 84 | nut | 86 | pivot bracket |
| 88 | wall | 90 | connector cable |
| 92 | lid | 94 | chassis |
| 96 | speaker | 98 | resonance chamber |
| 100 | bass port | 102 | port wall |
| 104 | port wall | 106 | left receiver |
| 108 | right receiver | 110 | center receiver |
| 112 | power supply | 114 | R/F module |
| 116 | amplifier | 118 | shelf |
| 120 | DVR | | |

### DETAILED DESCRIPTION OF THE INVENTION

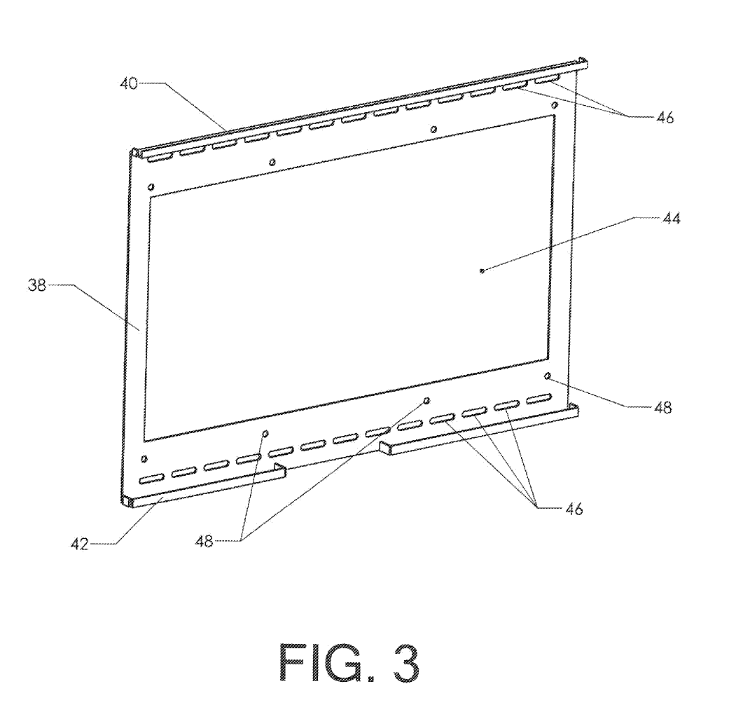

The present invention integrates a flat screen television and an external audio system into a unified mount. FIG. 3 shows an embodiment in which the unifying component is main bracket 38. This component includes upper flange 40 and two lower flanges 42. The two lower flanges are separated by a central gap. Numerous mounting slots 46 are provided to that the user may attach screws or bolts through these slots and attach main bracket 38 to a wall (as is known for prior art mounting brackets). These mounting slots 46 may also be used to attach main bracket 38 to a pedestal so that the unit may be placed on a flat surface.

Enclosure mounting holes 48 are provided so that an electronics enclosure may be attached to main bracket 38. One or more openings are preferably provided through the main bracket so that audio and/or video cables may be easily passed through the bracket. In the embodiment shown in FIG. 3, a single large opening 44 is provided for this purpose.

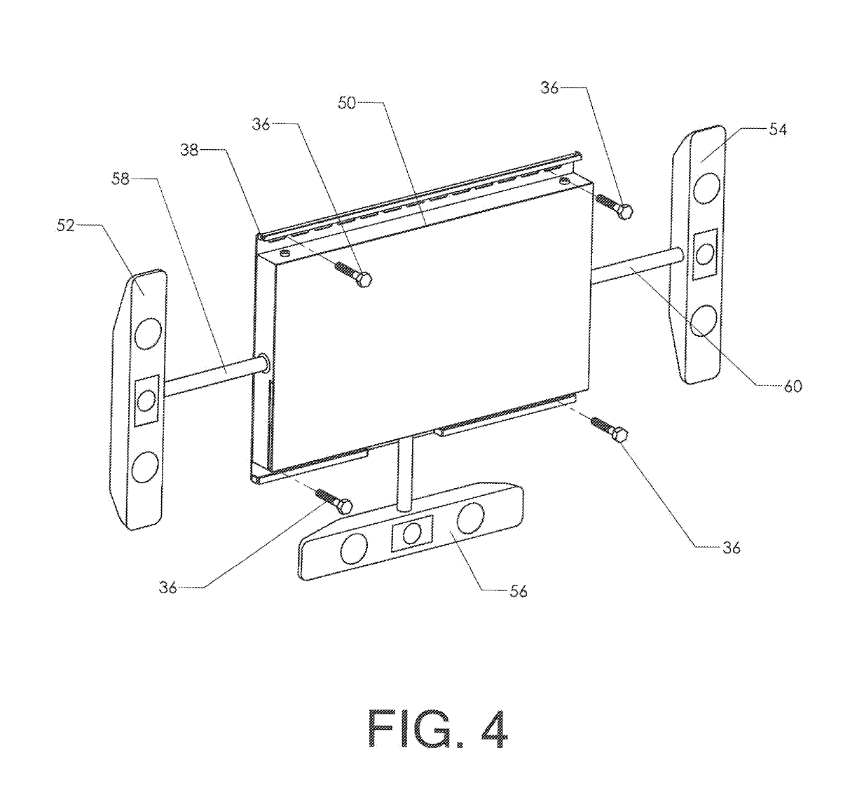

In FIG. 4, electronics/subwoofer enclosure 50 has been attached to main bracket 38. The electronics/subwoofer enclosure preferably contains an audio amplifier and an integrated bass speaker (though the bass speaker could be mounted outside the enclosure as well). The combination of main bracket 38 and electronics/subwoofer enclosure 50 is referred to as an “integration assembly.” This phrase is intended to encompass the many ways that an electronics enclosure can be integrated with the main bracket. As one example, those skilled in the art will know that the main bracket could actually form part of the electronics enclosure (such as by having the flat plate of the main bracket be the base of the enclosure).

Center support 62, left support 58, and right support 60 are all connected to the integration assembly. In the embodiment shown, they are actually connected to electronics/subwoofer enclosure 50. The supports are preferably adjustable in terms of extension. They can slide in and out of the electronics/subwoofer enclosure. They are preferably also pivotally adjustable.

Left speaker assembly 52 is attached to left support 58. Center speaker assembly 56 is attached to center support 62. Right speaker assembly 54 is attached to right support 60. The speaker assemblies may assume any desired form. The embodiments shown include three speakers each—in a linear array.

It is preferable to provide an electronics/subwoofer enclosure which may be attached to the main bracket before the main bracket is attached to the wall or a pedestal. FIG. 4 shows such a version. The reader will note that electronics/subwoofer enclosure 50 does not obstruct the mounting slots 46 on main bracket 38. Thus, a user is able to take the entire assembly shown in FIG. 4 and attach it to a wall (or pedestal) by passing several bracket mounting bolts 36 through the mounting slots 46 in main bracket 38. This may be done before or after the supports and associated speaker assemblies are installed.

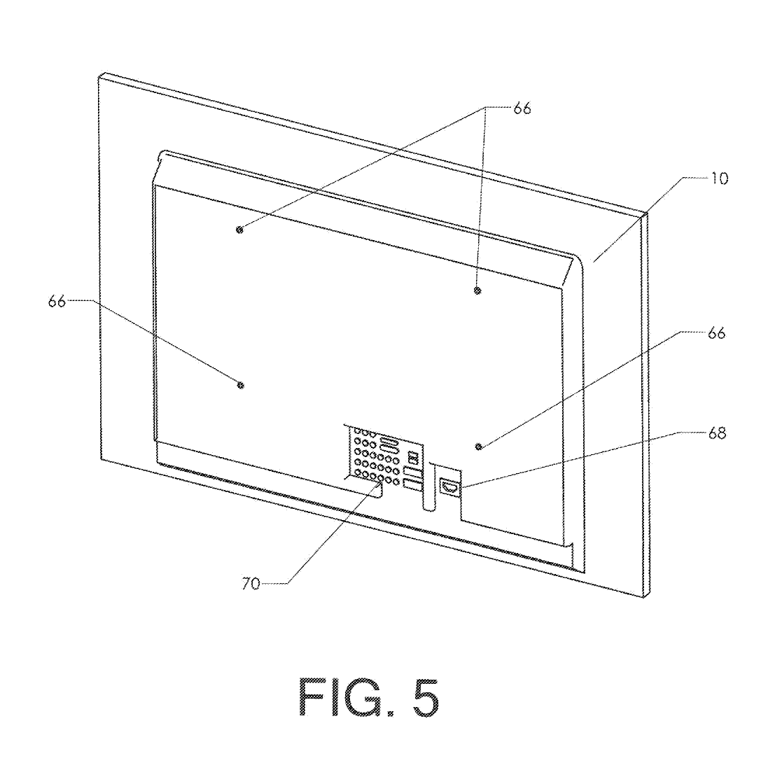

Once the main bracket is in position, the user will wish to attach the flat screen television. FIG. 5 shows flat screen TV 10 from the rear. The rear of such a television typically includes four or more threaded receivers 66. These are strong mounting points provided for the attachment of the television to a supporting bracket.

The rear of the television typically also includes A/V connection block 70 and power connection 68. The power connection allows a power cord to be plugged in. The A/V connection block typically provides for the connection of multiple cables of multiple types, including: HDMI, DVI, component video, S-video, composite video, RGB/VGA, and digital optical. The mounting system should provide access to the A/V connection block and the power connection.

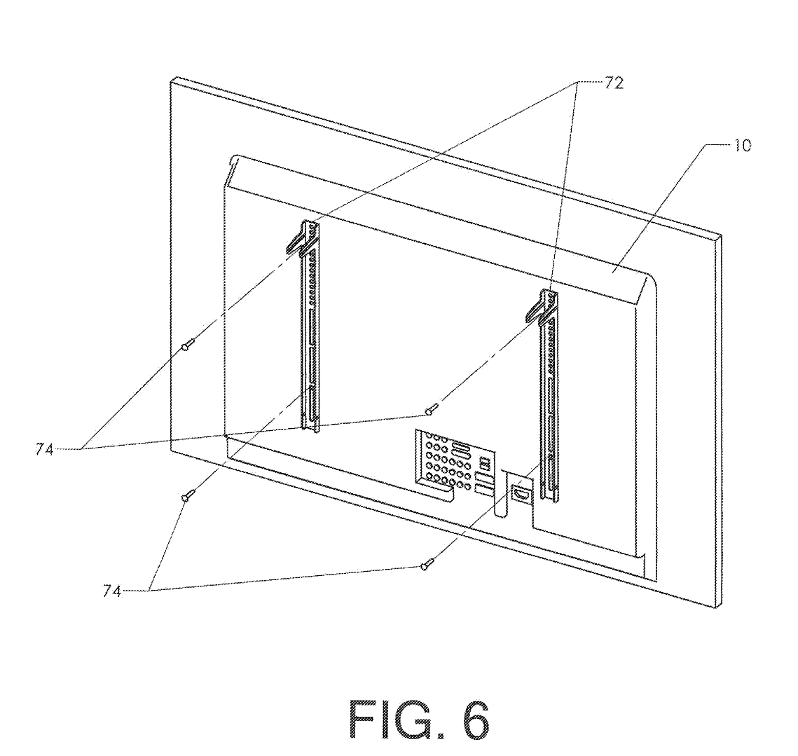

The physical connection made between the television and the main bracket can assume a virtually endless variety of forms. Thus, the embodiment shown in FIGS. 6, 7, and 10 is properly viewed as exemplary. In this embodiment, a pair of TV bracket 72 are connected to the back of flat screen TV 10 by passing TV bolts 74 through the TV brackets and into the threaded receivers 66 in the back of the TV.

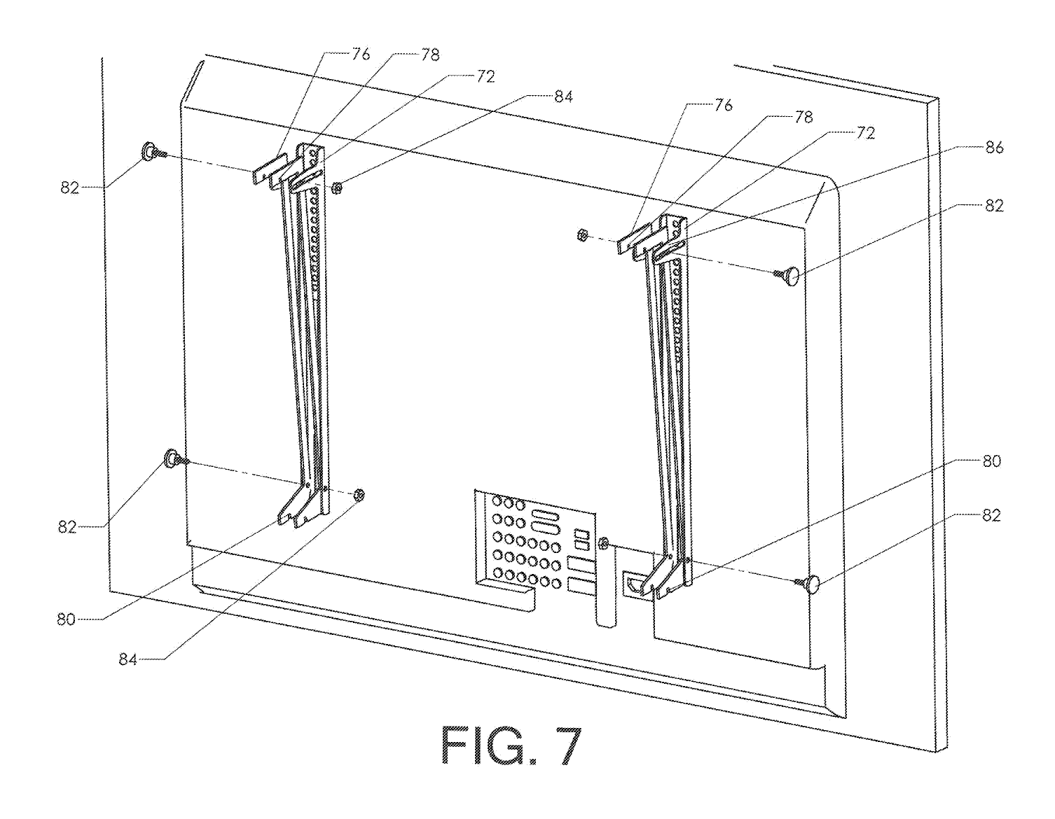

In FIG. 7, a gripping bracket 76 is shown attached to each of the TV brackets 72. Each gripping bracket pivots around a locking screw 82 which is passed through a hole through the gripping bracket and the TV bracket. The upper portion of each TV bracket includes a pivot bracket 86 with a slot. The upper portion of each gripping bracket 76 is secured by passing a locking screw 82 through the pivot bracket and through a hole in the upper portion of the gripping bracket. Nuts 84 are engaged by the locking screws.

The reader will thereby appreciate that each gripping bracket 76 may be pivoted with respect to its connected TV bracket 72. The desired pivot position may then be secured by tightening the appropriate locking screw 82. The design shown allows the reader to adjust the tilt of the television after it is attached to the main bracket—as will be explained subsequently.

The two gripping brackets 76 are provided with features allowing them to be fastened to main bracket 38. The reader will note that the upper portion of each gripping bracket has an extension extending toward the rear. This extension includes an upper notch 78. The lower portion of each gripping bracket likewise includes a lower notch 80. The upper notches are sized and positioned to slip over and engage upper flange 40 on main bracket 38 while the lower notches are sized and positioned to slip over and engage lower flange 42 on main bracket 38. The notches preferably have a tapered entry, fillets, or other similar features to help the user engage the gripping brackets with the main brackets.

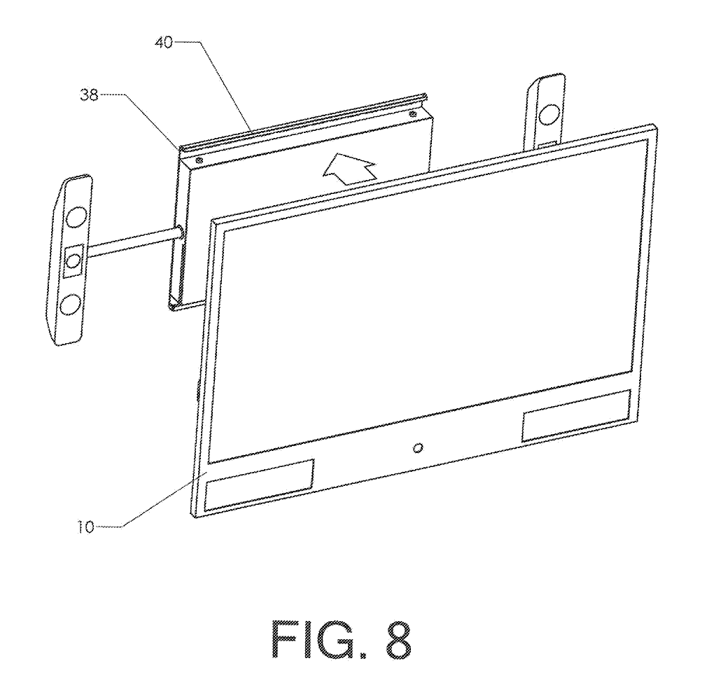

Turning now to FIG. 8, the reader will observe that main bracket 38 with its attached electronics/subwoofer enclosure and speaker assemblies (an integration assembly plus the speaker mounts and speakers) has been attached to a wall. The appropriate mounting brackets (TV brackets and gripping brackets) have been attached to the rear of flat screen TV 10. The user moves the flat screen TV toward the integration assembly as shown by the arrows. He or she slips the upper notches 78 over the upper flange 40 and the lower notches 80 over the lower flange 42 in order to attach the TV to main bracket 38.

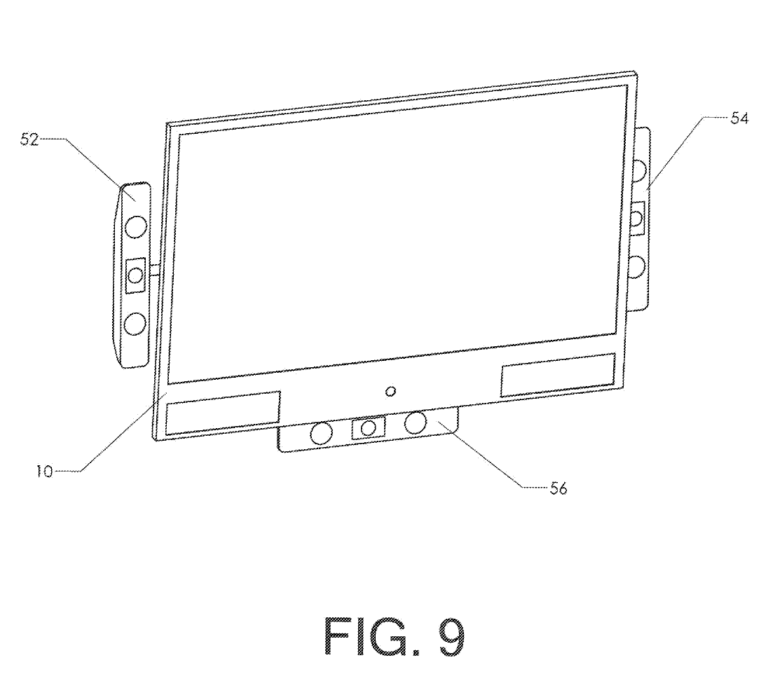

FIG. 9 shows the assembly with flat screen TV 10 in position. The speaker assemblies (left speaker assembly 52, right speaker assembly 54, and center speaker assembly 56) are positioned as the user desires. Prior to installing the TV the user will typically extend supports 58, 60, and 62 to move the speakers will clear of the TV. Once the TV is in position and adjusted, the user may then push the speaker assemblies up against the perimeter of the TV and adjust the rotation of the speaker assemblies as desired.

Supports 58, 60, and 62 preferably include frictional or other features which allow them to be adjusted but maintain position once the adjustment is made. FIG. 9 shows the TV titled somewhat forward. As an example of a typical adjustment, the user may tilt left speaker assembly 52 and right speaker assembly 54 forward in order to match the adjustment of the TV.

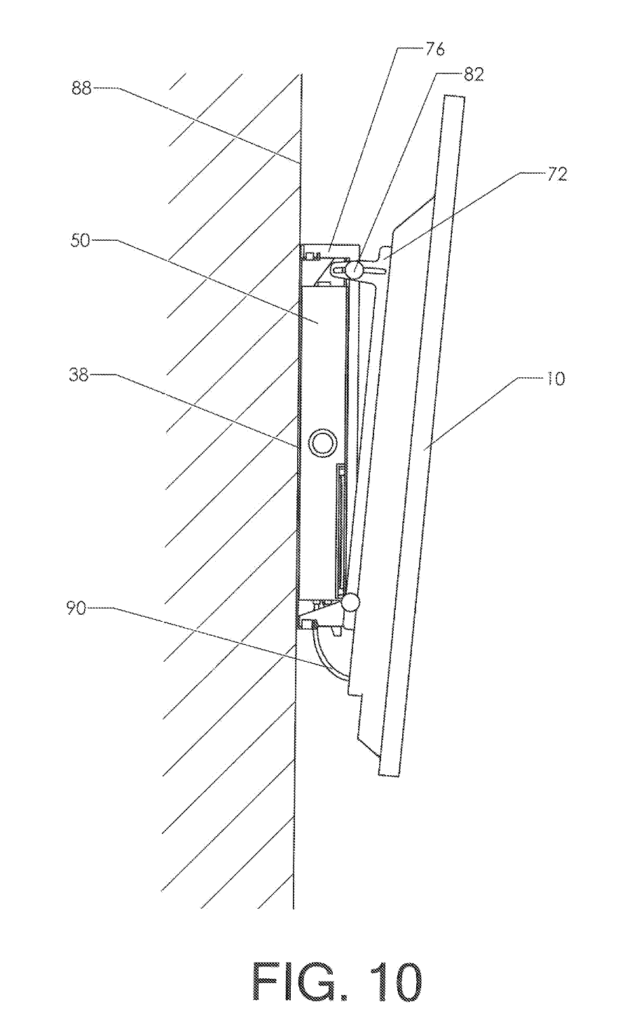

FIG. 10 shows a side elevation view of the assembly mounted on the wall. Left speaker assembly 52 is removed in this view for visual clarity. Main bracket 38 is attached to wall 88. The reader will observe how the notches in the gripping brackets are engaged over the upper and lower flanges in main bracket 38. The reader will also observe how the tilt of the TV may be adjusted without removing it from main bracket 38. Tilt may be adjusted by reaching in from the side and loosening locking screws 82, repositioning the TV, and then retightening the locking screws.

FIG. 10 shows how electronics/subwoofer enclosure 50 neatly fits into the available space between flat screen TV 10 and wall 88. Room is also available to connect the electronics/subwoofer enclosure 50 with the TV, if the installation is a type requiring such a connection. In the example shown, connector cable 90 connects electrical components within the electronics/subwoofer enclosure to flat screen TV 10.

The specific design of the mounting bracketry is not significant to the present invention. Thus, the reader should bear in mind that the invention includes many different types of mounting arrangements that may appear and function in different ways from the illustrated embodiment.

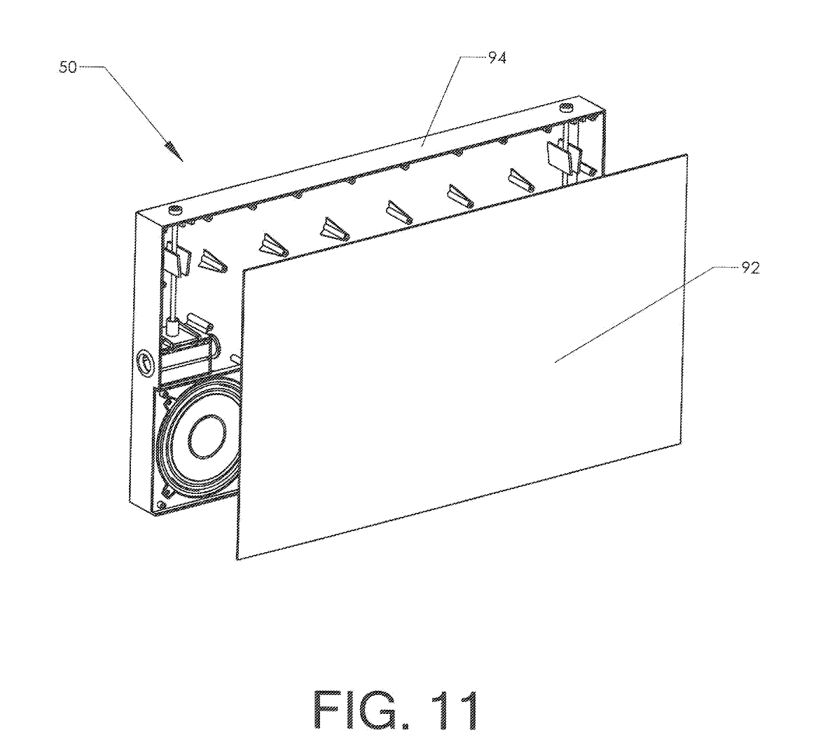

Likewise, the design of the electronics enclosure may assume many forms. However, as it may aid the reader's understanding, a detailed description of one embodiment will be provided. FIG. 11 shows an exploded view of electronics/subwoofer enclosure 50. Chassis 94 contains the components. It is covered by lid 92, which may be snapped or screwed into place. These components may be made of fiber-reinforced thermoplastic, metal, or other suitable materials.

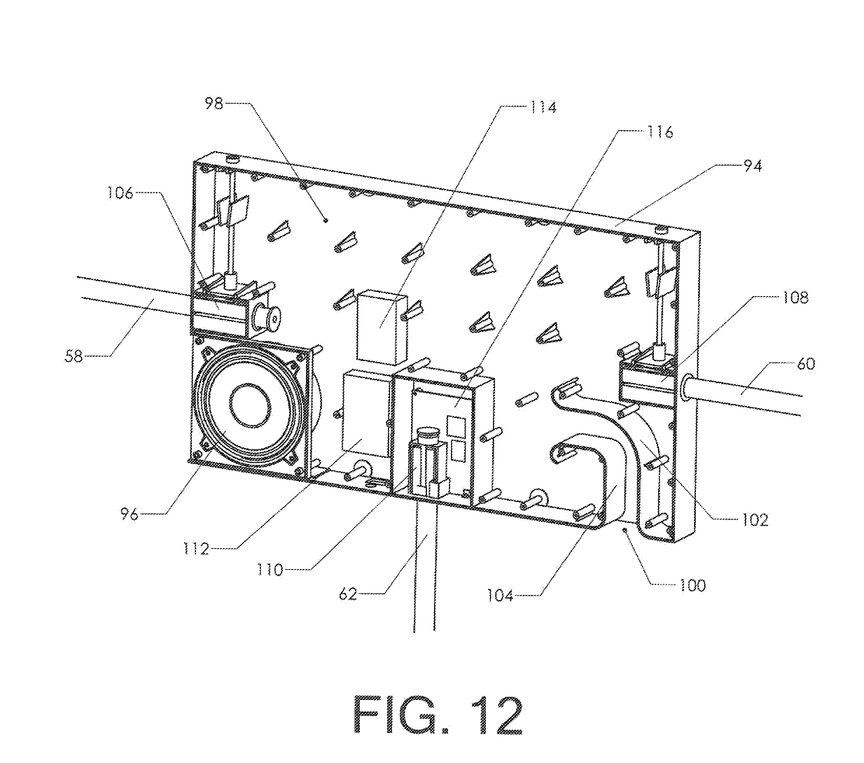

FIG. 12 shows chassis 94 with the lid fully removed. The chassis includes interior bulkheads surrounding amplifier. 116. Speaker 96 preferably performs the role of a “subwoofer,” meaning that it is designed to handle relatively low frequency sounds. It will be referred to herein as a “bass speaker.” The output of base speaker 96 is open to the interior of the chassis. The interior forms a resonance chamber 98. The chassis also includes bass port 100 bounded by port wall 102 and port wall 104. The bass port is positioned to emit relatively low frequency tones generated by bass speaker 96.

The chassis includes other features as well. In the embodiment shown, the speaker supports (left support 58, right support 60, and center support 62) are all attached to the electronics/subwoofer enclosure. This need not always be the case as they could be attached directly to main bracket 38 or some other component. However—in the embodiment shown—left support 58 is slidably and pivotally received within left receiver 102. Right support 60 is slidably and pivotally received within right receiver 108. Center support 62 is slidably and pivotally received within center receiver 110.

As stated previously, the receivers are preferably equipped with frictional features which allow adjustment but tend to retain the speaker assemblies in position once the user releases them. One example of a frictional fit is to make the speaker support tubular and provide the receivers with NYLON bushings which fit tightly around the tubes.

Other components may he contained within the chassis. Power supply 112 provides power to amplifier 116. R/F module 114 may be provided to supply wireless outputs to some or all of the speakers. The connections between the audio amplifier and the left, right, and center speaker assemblies may be hard-wired, wireless, or a mixture of the two.

Amplifier 116 may assume many forms. In some instances it may be a pass-through device which simply passes through the channel-specific signals received from an external surround-sound amplifier. In other instances it may itself be a sophisticated surround sound amplifier which receives an input signal from a cable or satellite feed and splits that signal into the appropriate channels, including, left, right, center, and rear.

In some versions the amplifier may receive its input from the flat screen TV. In other versions the amplifier will receive its input from an external cable or satellite decoder with no connection being made between the amplifier and the TV itself.

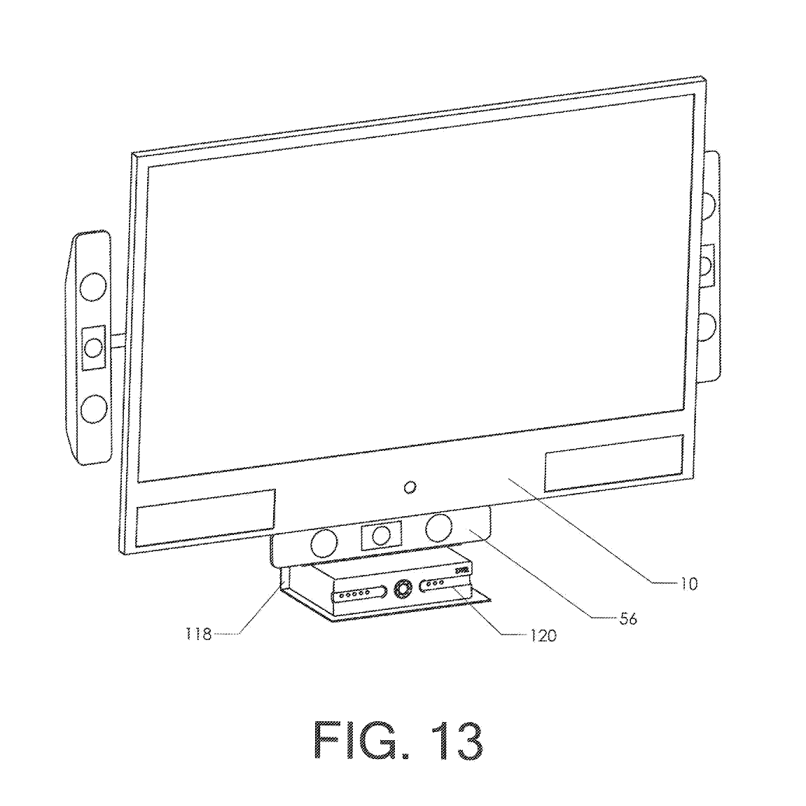

Other features may be added to the integrated system. FIG. 13 shows an embodiment in which suspended shelf 118 has been added beneath center speaker assembly 56. The shelf may be attached to a suitable point such as center support 62 or the center speaker assembly itself. Another component, such as DVR 120, may be placed on the shelf. In some embodiments the electronics/subwoofer enclosure will include electrical connections for many different types of components, including DVR's and DVD players.

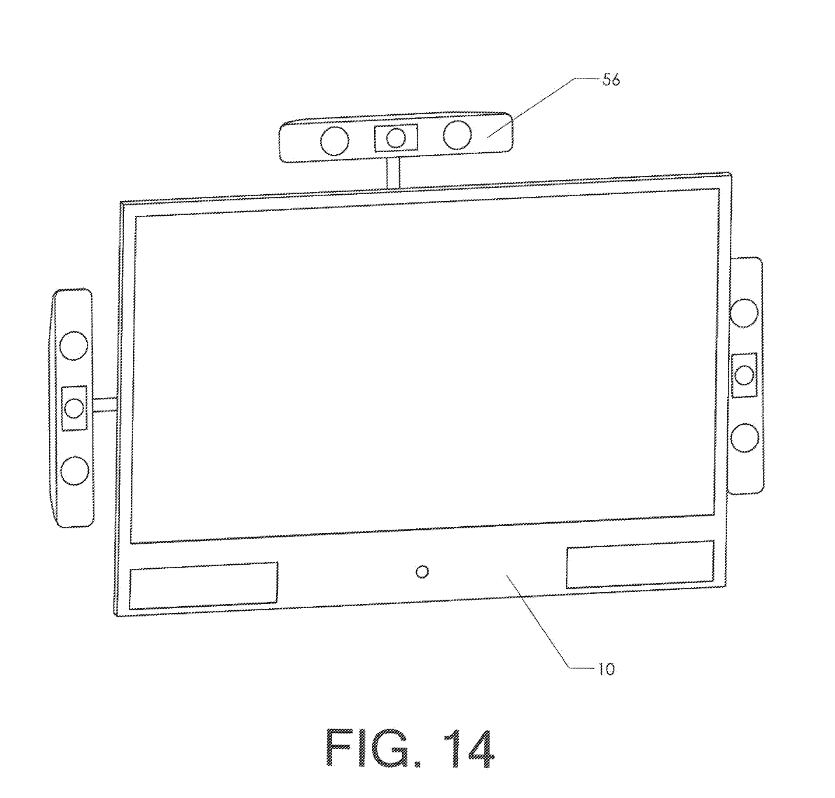

The specific speaker configurations and positions shown in the invention should not be viewed as limiting. FIG. 14 shows another embodiment in which center speaker assembly 56 is placed above the TV position. In this case center support 62 extends out of the top of the electronics/subwoofer enclosure rather than the bottom.

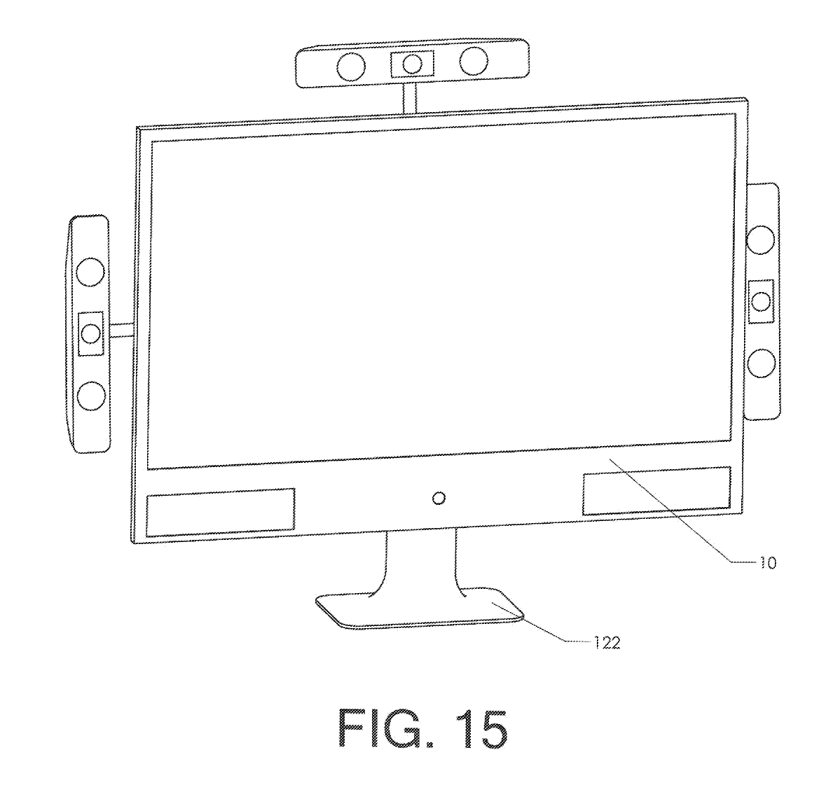

As disclosed previously, main bracket 38 may be configured to mount to a wall or to a pedestal. It is even possible to provide a main bracket which can be optionally attached to either a wall or a pedestal. FIG. 15 shows an embodiment in which the main bracket has been attached to pedestal 122 and the entire assembly has been placed upon a horizontal surface. In such a case the main bracket may not look like the example shown in FIG. 3 but may instead assume a different form.

The preceding description contains significant detail regarding the novel aspects of the present invention. It should not be construed, however, as limiting the scope of the invention but rather as providing illustrations of the preferred embodiments of the invention. As an example, although the illustrated embodiments show a design wherein the bass speaker is mounted within the electronics/subwoofer enclosure, the bass speaker could actually be mounted adjacent to the electronics enclosure in a completely separate enclosure. Thus, the scope of the invention should be fixed by the following claims, rather than by the examples given.

Having described our invention, we claim:

1. An integrated audio visual entertainment system, comprising:
a. a main bracket;
b. an electronics/subwoofer enclosure connected to said main bracket to form an integration assembly;
c. a center support connected to said integration assembly;
d. a center speaker assembly connected to said center support;
e. a television;
f. a gripping bracket connected to said television, with said gripping bracket being releasably secured to said main bracket;
g. said electronics/subwoofer enclosure including,
i. a bass speaker,
ii. a resonance chamber fluidly connected to said bass speaker,
iii. a bass port fluidly connected to said resonance chamber,
iv. an audio amplifier; and
h. wherein said center speaker is connected to said audio amplifier and said bass speaker is connected to said audio amplifier.

2. An integrated audio visual entertainment system as recited in claim 1, further comprising:
a. a left support connected to said integration assembly;
b. a left speaker assembly connected to said left support;
c. a right support connected to said integration assembly; and
d. a right speaker assembly connected to said right support.

3. An integrated audio visual entertainment system as recited in claim 1, wherein said center support is slidably adjustable with respect to said integration assembly.

4. An integrated audio visual entertainment system as recited in claim 1, wherein said center support is pivotally adjustable with respect to said integration assembly.

5. An integrated audio visual entertainments system as recited in claim 1, further comprising a shelf attached to said integration assembly.

6. An integrated audio visual entertainment system as recited in claim 2, wherein said center support, said left support, and said right support are slidably adjustable with respect to said integration assembly.

7. An integrated audio visual entertainment system as recited in claim 2, wherein said left support and said right support are pivotally adjustable with respect to said integration assembly.

8. An integrated audio visual entertainment system, comprising:
a. a main bracket;
b. an electronics/subwoofer enclosure connected to said main bracket;
c. a first support connected to said electronics/subwoofer enclosure;
d. a first speaker assembly connected to said first support;
e. a television;
f. a gripping bracket connected to said television, with said gripping bracket being releasably secured to said main bracket
g. said electronics/subwoofer enclosure including,
i. a bass speaker,
ii. an audio amplifier; and
h. wherein said first speaker assembly is connected to said audio amplifier and said bass speaker is connected to said audio amplifier.

9. An integrated audio visual entertainment system as recited in claim 8, further comprising:
a. a second support connected to said electronics/subwoofer enclosure;
b. a second speaker assembly connected to said second support;
c. a third support connected to said electronics/subwoofer enclosure; and
d. a third speaker assembly connected to said third support.

10. An integrated audio visual entertainment system as recited in claim 8, wherein said first support is slidably adjustable with respect to said electronics/subwoofer enclosure.

11. An integrated audio visual entertainment system as recited in claim 8, wherein said first support is pivotally adjustable with respect to said electronics/subwoofer enclosure.

12. An integrated audio visual entertainment system as recited in claim 8, further comprising a shelf attached to said main bracket.

13. An integrated audio visual entertainment system as recited in claim 9, wherein said first support, said second support, and said third support are slidably adjustable with respect to said electronics/subwoofer enclosure.

14. An integrated audio visual entertainment system as recited in claim 9, wherein said second support and said third support are pivotally adjustable with respect to said electronics/subwoofer enclosure.

15. An integrated audio visual entertainment system, comprising:
a. a main bracket;
b. an electronics enclosure connected to said main bracket to form an integration assembly;
c. a first support connected to said integration assembly;
d. a first speaker assembly connected to said first support;
e. a television;
f. a gripping bracket connected to said television, with said gripping bracket being releasably secured to said integration assembly;
g. said electronics enclosure including an audio amplifier;
h. a bass speaker connected to said integration assembly; and
i. wherein said first speaker assembly is connected to said audio amplifier and said bass speaker is connected to said audio amplifier.

16. An integrated audio visual entertainment system as recited in claim 15, further comprising:
a. a second support connected to said integration assembly;
b. a second speaker assembly connected to said second support;
c. a third support connected to said integration assembly; and
d. a third speaker assembly connected to said third support.

17. An integrated audio visual entertainment system as recited in claim 15, wherein said first support is slidably adjustable with respect to said integration assembly.

18. An integrated audio visual entertainment system as recited in claim 15, wherein said first support is pivotally adjustable with respect to said integration assembly.

19. An integrated audio visual entertainments system as recited in claim 15, further comprising a shelf attached to said integration assembly.

20. An integrated audio visual entertainment system as recited in claim 16, wherein said first support, said second support, and said third support are slidably adjustable with respect to said integration assembly.

21. An integrated audio visual entertainment system as recited in claim 16, wherein said second support and said third support are pivotally adjustable with respect to said integration assembly.
